(19) United States
(12) Patent Application Publication
(10) Pub. No.: US 2009/0075525 A1
(43) Pub. Date: Mar. 19, 2009

(54) PHOTOVOLTAIC PLUG-TYPE CONNECTOR

(76) Inventor: Othmar Gaidosch, Ostfildern (DE)

Correspondence Address: K.F. ROSS P.C., 5683 RIVERDALE AVENUE, SUITE 203 BOX 900, BRONX, NY, 10471-0900, US

(21) Appl. No.: 12/204,899

(22) Filed: Sep. 5, 2008

(30) Foreign Application Priority Data
Sep. 5, 2007 (DE) 102007041989.0

(51) Int. Cl. H01R 13/514; H01R 24/00

(52) U.S. Cl. 439/701; 439/660

(57) ABSTRACT

The invention relates to a plug (1.1), preferably for use outside in solar-energy systems, which plug (1.1) comprises a contact carrier (1.1.1) in which a contact pin (1.1.2) is arranged and fastened, which contact carrier (1.1.1) carries on the end a cable sealing ring (1.1.3) with a strain-relief hook (1.1.4), which strain-relief hook (1.1.4) cooperates with a threaded compression sleeve (1.1.5) in order to decouple forces of traction and pressure that act on a cable (1.1.6) from the contact pin (1.1.2). The corresponding socket (1.2) is designed in analogy with the above.

The invention relates to a plug-type connector, preferably for use outside in solar-energy systems for connecting solar panels together, in accordance with the features of the particular introductory clauses of the independent patent claims.

Such plug-type connectors are exposed for very long periods of time (>25 years) to all influences of weather and the environment occurring at the site of use and must resist them without their functioning being adversely affected. In addition, stringent electrical and mechanical requirements must also be met that occur in such systems. Since such plug-type connectors can basically be touched at any time and are also readily accessible as regards improper manipulation (e.g. separating under load by children, by stumbling over exposed cables, etc.), the appropriate authorities (TÜV, UL, etc.) have also placed very high requirements of approval and safety on them. In spite of all these performance features to be met, special attention must be paid in particular in the case of rather high numbers to the economy of the concept.

The invention therefore has the basic object of eliminating these disadvantages and of providing an improved plug connector.

The invention has the object of providing compactly built plug-type connector pairs for photovoltaic that can be manufactured as economically as possible with molding technology, can also be freely assembled and of course can be compatibly plugged into each other.

This problem is solved on the one hand by a plug in accordance with the invention and on the other hand by a socket in accordance with the invention, which plug and socket form a plug-type connector that when fitted together creates an electrical connection from a solar panel to a device to which it is connected.

The plug comprises a contact carrier in which a contact pin is arranged and fastened, which contact carrier carries on its end a cable sealing ring with a strain-relief hook, which strain-relief hook is acted on by a threaded compression sleeve in order to decouple forces of attraction and pressure that act on the cable from the contact pin.

The socket is constructed in an analogous form and also comprises a contact carrier in which a female contact is arranged and fastened, which contact carrier carries on its end a cable sealing ring with a strain-relief hook, which strain-relief hook is held by a threaded compression sleeve in order to decouple forces of traction and compression that act on the cable from the contact pin.

The cooperation of strain-relief hook and threaded compression sleeve has the advantage that the plug as well as the socket are sealed on the end in the cable connection area. In order to prevent the moisture from penetrating on the insertion side a seal is also provided between the contact carrier of the plug and the contact carrier of the socket, which seal is preferably constructed as an O-ring. However, it is also conceivable here that the seal is produced on manufacture of the contact carrier of the plug and/or of the socket in a two-component injection molding process. This has the advantage that in such a case the seal is arranged on the contact carrier of the plug and of the socket in such a manner that it cannot be lost.

According to the invention that the contact carrier of the plug or of the socket is formed by a plastic molded around it. In the case of the plug the contact pin and in the case of the socket the female contact is fixed in the respective contact carrier by molding. This has the advantage that as a result any desired shapes can be realized for a contact carrier by the appropriate shape of the injection-molding mold. The contact carrier can also be adapted rapidly and in a simple manner here to different shapes of the contact pins and female contacts.

It is alternatively provided that the contact carrier of the plug or of the female contact is again formed by molded plastic; however, the contact pin is fastened in the plug and the female contact in the socket integrally in the contact carrier. This can take place, for example, by being pressed in, clipped in or the like. An adhesive connection is also conceivable.

In a further embodiment of the invention the contact pin of the plug and the female contact of the socket are designed as a stamped roll contact. This has the advantage that the particular contact can be manufactured rapidly and economically in the desired shape.

A further development of the invention provides that the contact pins of the plug have latch seats and the contact carrier of the socket comprises stop barbs (or vice versa), which latch seats on the plug are designed to be so small that the stop barbs on the socket cannot be loosened by finger pressure. This has the significant advantage that the assembled plug-type connector can only be released subsequently with the aid of an appropriate tool, so that an inadvertent separation of the plug and the socket can be effectively prevented.

Based on the above, a further development of the invention provides that the outer surfaces on the stop noses of the stop barbs are held in the locked state recessed by a corresponding degree relative to the outer jacket surface of the associated contact carrier. This has the advantage that the stop noses of the stop barbs do not project beyond the outer contour of the contact carrier and in this manner inadvertent actuation is effectively avoided.

Further embodiments of the invention are described in the following and are explained in the drawings using illustrated embodiments that do not, however, limit the invention.

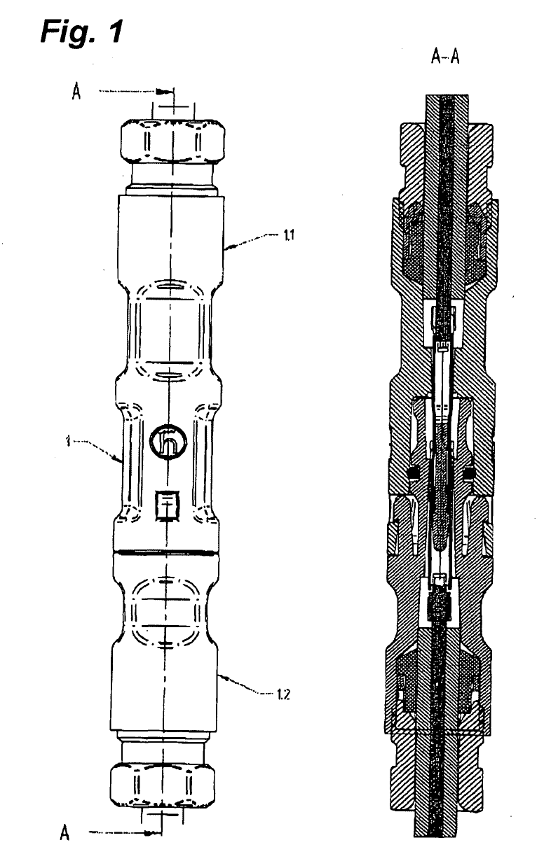

FIGS. 1 to 3 show, to the extent they are shown in detail, the plug-type connector 1, which consists of a plug 1.1 and a socket 1.2. FIG. 1 shows the inner workings of this assembled plug-type connector in section A-A and the following figures are referred to for further details.

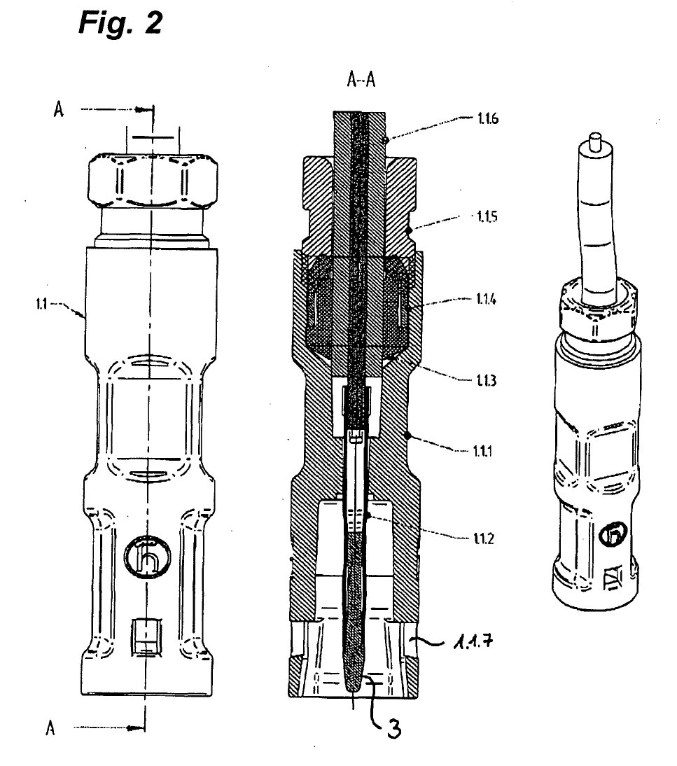

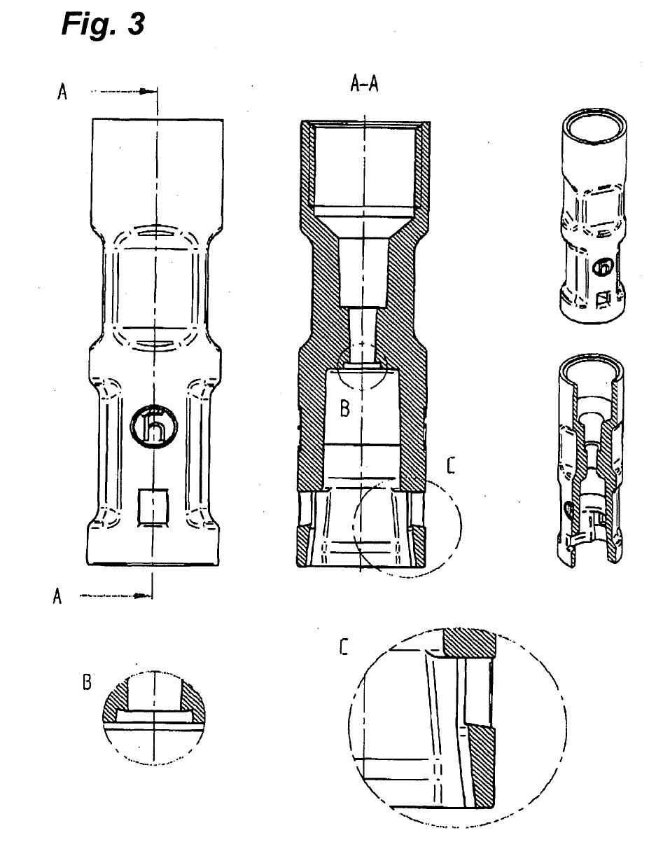

FIGS. 2 and 3 show in detail the plug 1.1 that comprises a contact carrier 1.1.1 in which a contact pin 1.2 is mounted and secured and that carries a cable seal 1.1.3 with a strain-relief hook 1.1.4 that is held by a threaded compression sleeve 1.1.5 in order to decouple forces of traction and pressure acting on the cable 1.1.6 from the contact pin 1.1.2. 1.1.7 designates latch seats that cooperate with stop barbs of the socket 1.2 that have not been shown here.

FIG. 3 shows details of the plug 1.1, in which particular reference is made to the details in view B and in view C. Detailed view B concerns the design of an entry area for the contact pin 1.1.2, in which area a shoulder shown in detailed view B is provided. The latch seats 1.1.7 can be recognized in detailed view C and the contact carrier is designed to flare conically in the direction of insertion, starting from the latch seats 1.1.7, in order to facilitate a plugging together of plug and socket.

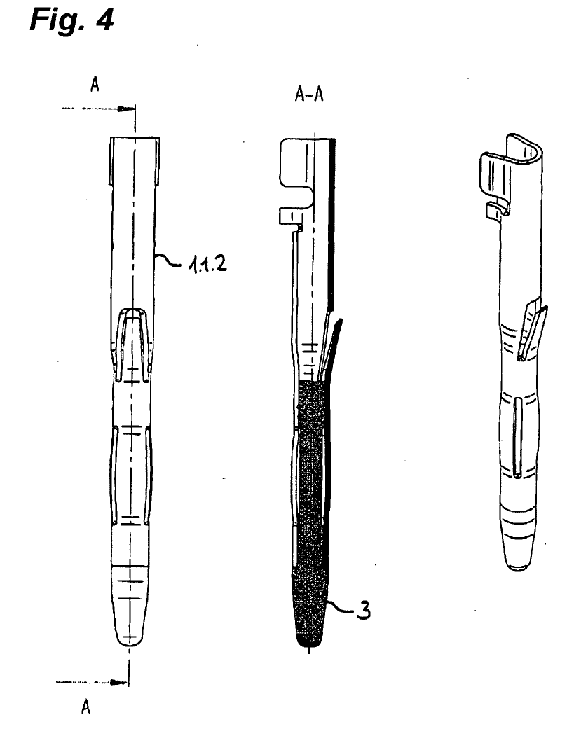

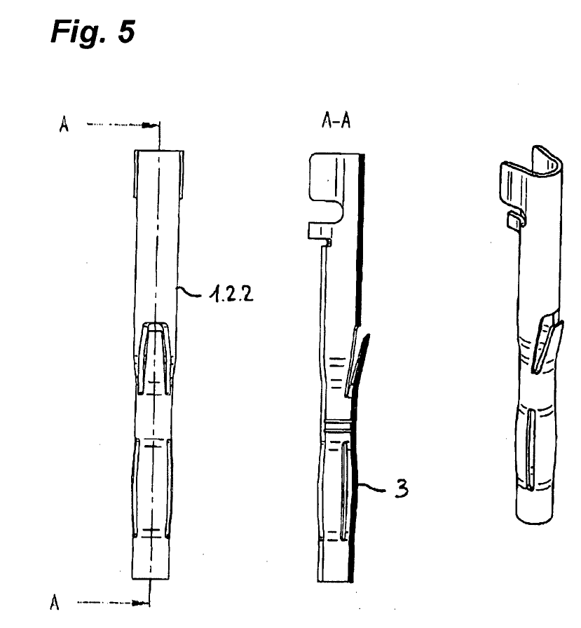

FIG. 4 shows a concrete design of the contact pin 1.1.2 and in FIG. 5 the concrete design of a female contact for the socket is shown.

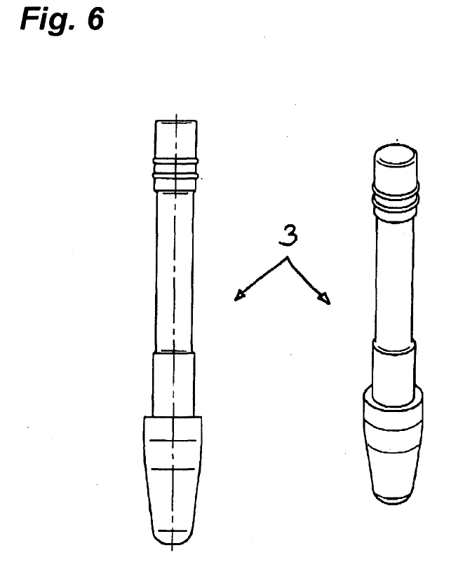

A further important and significant element for the plug-type connector in accordance with the invention is shown in FIG. 6 in the form of a contact protector 3. The contact protector 3 shown in FIG. 6 is inserted into a contact pin 1.1.2 in such a manner that contact surfaces of the contact pin 1.1.2 inside the contact carrier remain free for the female contact 1.2.1 but a contact protector is present on the end, that is, to the front in the direction of the plug area. To this end the contact protector 3 is designed from an electrically non-conductive material such as e.g. a plastic. The contact protector 3 is present in an analogous form, that is, adapting shape to the female contact 1.2.1, in FIG. 5, where the contact protector 3 is arranged on the outer surface of the female contact 1.2.1 in order to avoid unintentional contact with the female contact 1.2.1 carried in the contact carrier 1.1.1 of the socket 1.2.

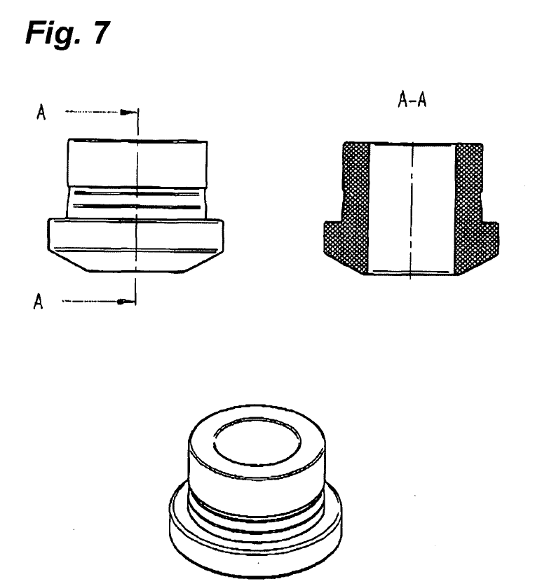

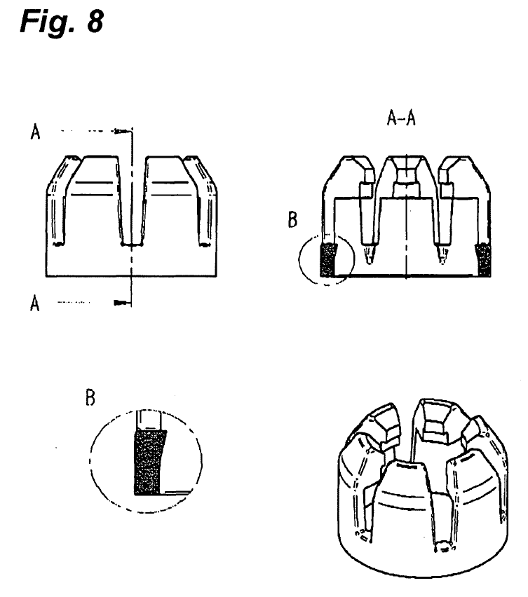

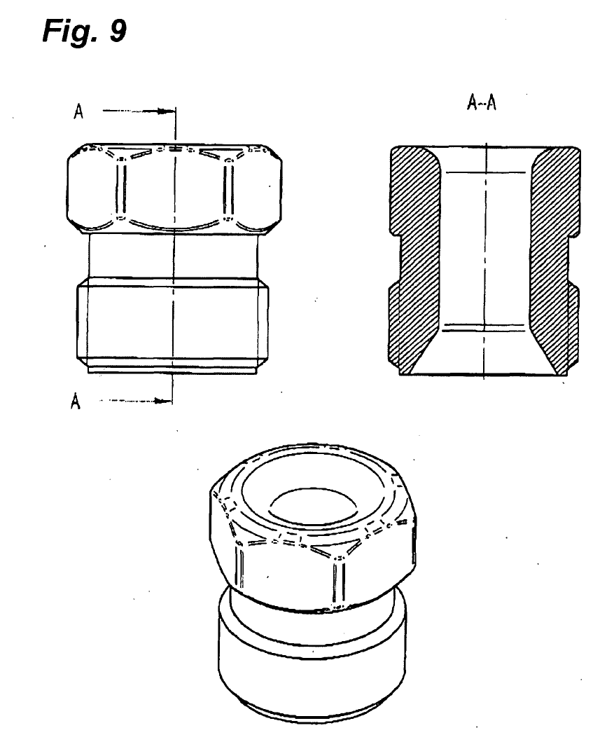

FIGS. 7 to 9 show the cable sealing ring 1.1.3, the strain-relief hook 1.1.4 as well as the associated threaded compression sleeve 1.1.5 in detail. These previously cited elements are all preferably made of plastic and can be made of the same or a different plastics with the strain-relief hook 1.1.4 as well as the threaded compression sleeve 1.1.5 preferably made of a rigid plastic and the cable sealing ring 1.1.3 preferably consisting of an elastically deformable plastic.

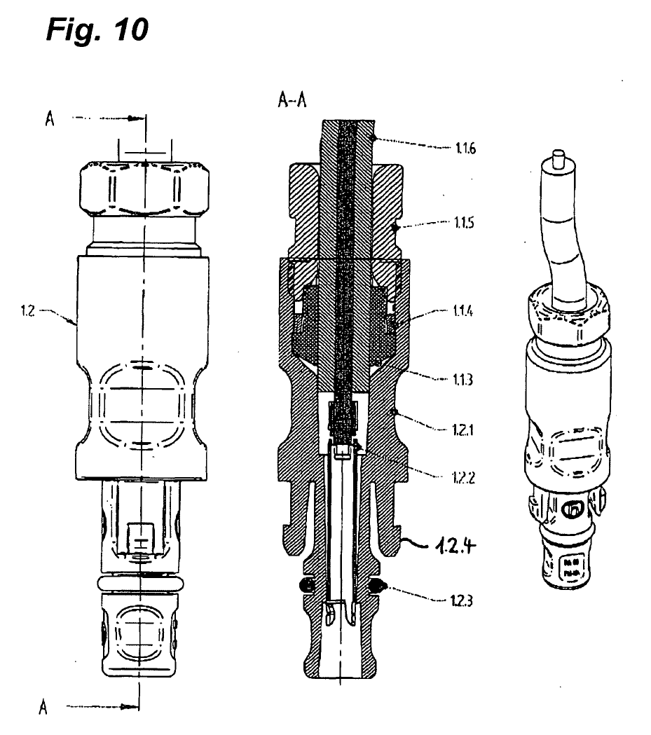

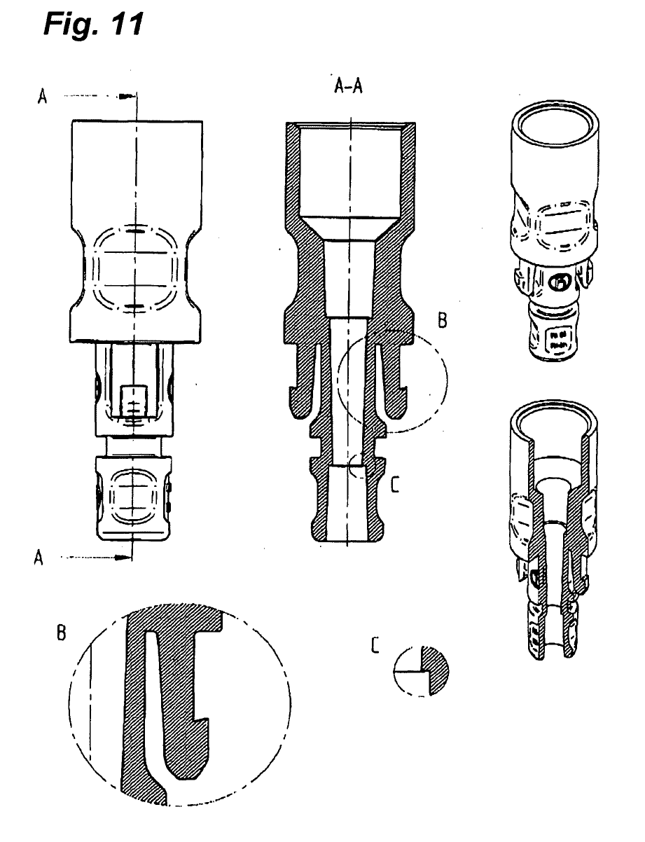

FIGS. 10 and 11 show, in analogy with FIGS. 2 and 3, the socket 1.2 in particular embodiments.

In order to seal the plug 1.1 in the assembled state a radially circumferential seal 1.2.3 is present in the plug area of the socket 1.2.

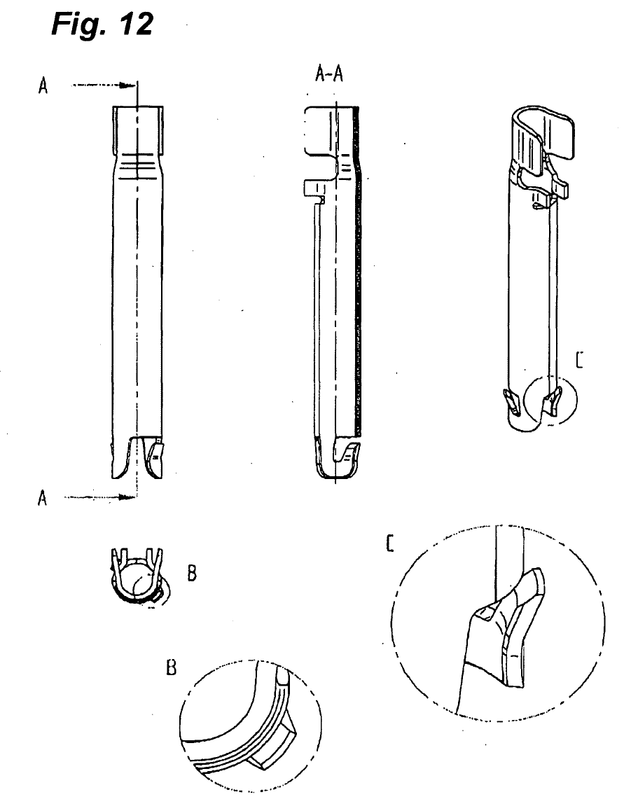

FIG. 12 shows a detailed design of a female contact 1.2.1 that is advantageously designed as a stamped roll contact. Contact wings with which an electrical conductor of cable 1.1.6 is crimped onto the contact are present on the end in the contact area shown in detailed view B. Other projecting wings axially offset somewhat below them that function as stop barbs in order fix the female contact 1.2.1 in the associated contact carrier. Projecting and outwardly facing wings are present on the other side of the female contact shown in detail C with which insertion of the contact pin into the female contact is facilitated.

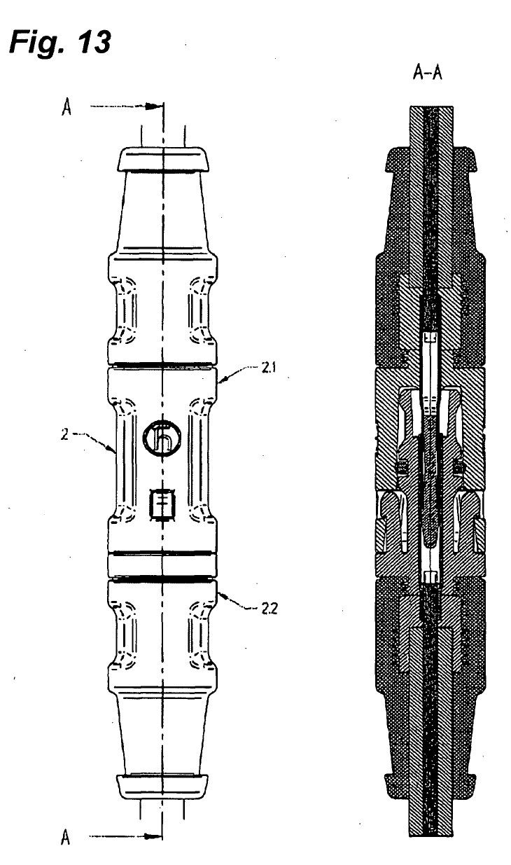

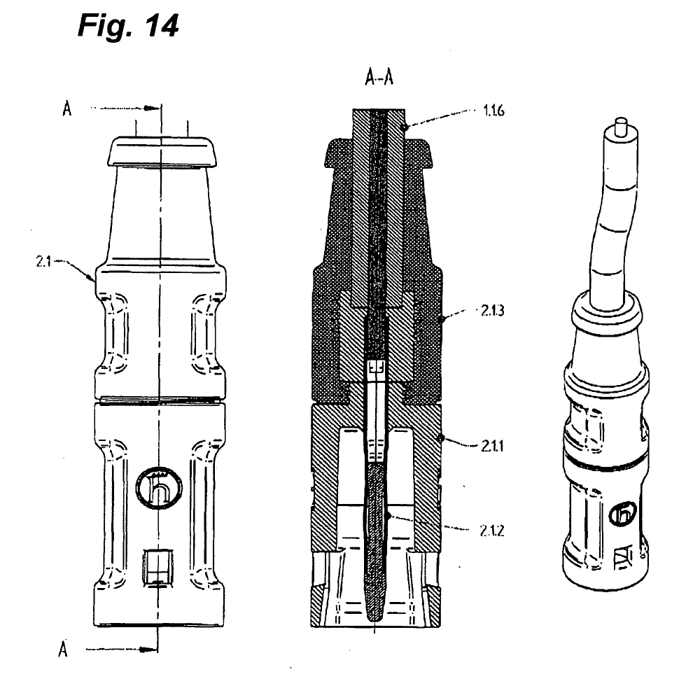

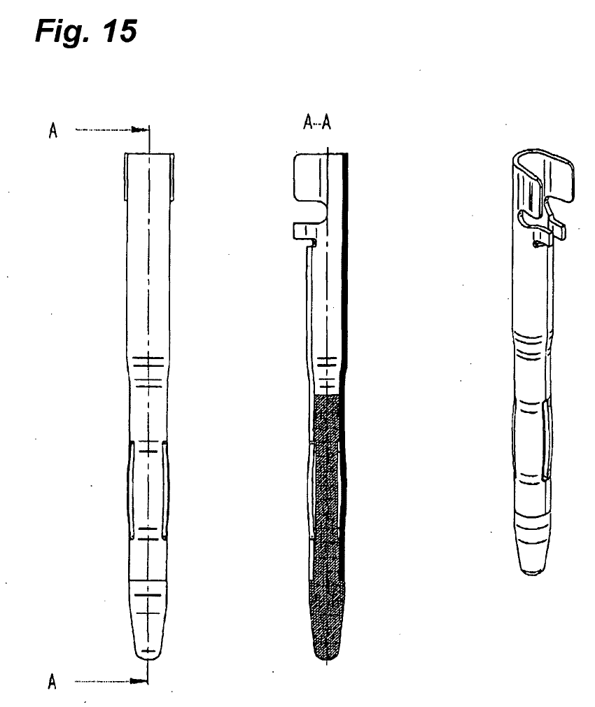

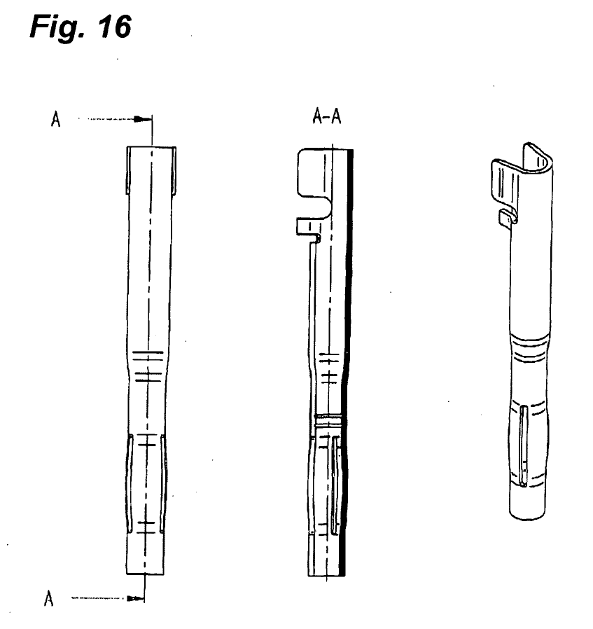

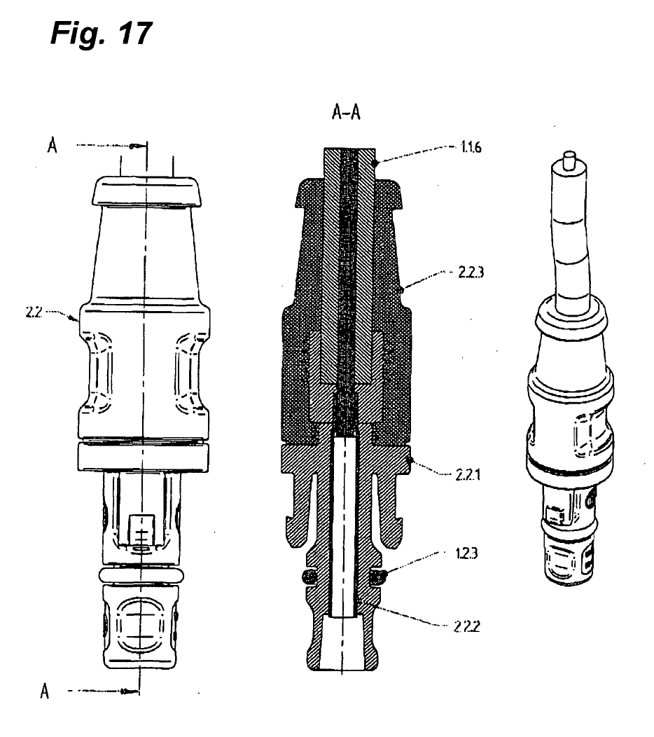

FIGS. 13 to 18 shows alternative embodiments of the plug-type connector of the invention to which the features of the claims also apply. In FIG. 13 a plug-type connector 2 consisting of plug 2.1 and socket 2.2 can be seen with its inner workings (section A-A). FIG. 14 shows the plug 2.1, in which embodiment the contact carrier is divided into two parts and is formed by the two parts 2.1.1, that carries the contact pin 2.1.2 and the end part 2.1.3 from which the cable 1.1.6 extends out. The associated contact pin, also provided with contact protector 3, is shown in FIG. 15. The analogous female contact is shown in FIG. 16, also provided with a contact protector, and the socket 2.2 associated with the female contact is shown in FIG. 17. It can also be seen here that this socket 2.2 comprises a contact carrier 2.2.1 divided into two parts with female contact 2.2.2, which contact carrier part 2.2.1 is connected to the other part 2.2.3 from which the cable 1.1.6 is run out. The contact carrier parts 2.1.1 and 2.1.3 of the plug 2.1 and the contact carrier parts 2.2.1 and 2.2.3 of socket 2.2 are preferably manufactured in a two-component injection molding process during which the particular contacts 2.1.2 and 2.2.2, that are fastened to the end of the cable 1.1.6 and electrically contacted, are placed into the injection molding tool and the molding subsequently takes place with two different plastics in such a manner that the previously cited contact carrier parts are formed.

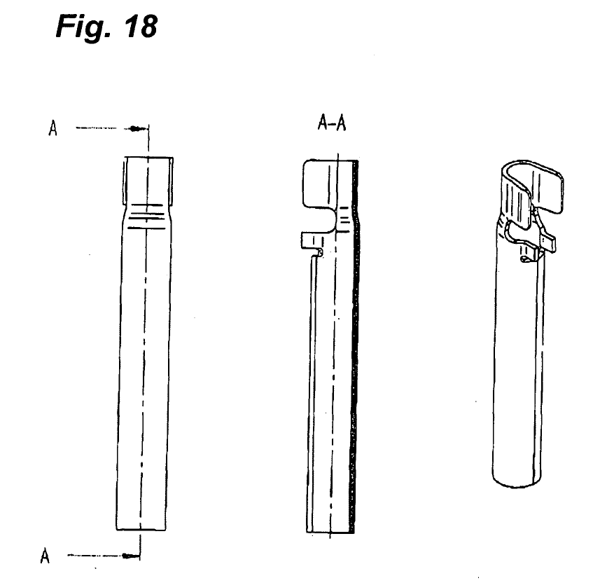

The solution present here operates, in particular as regards economy, with electrical contacts—preferably with stamped rolling contacts—that are on the one hand as inexpensive as possible and on the other hand can be used in molded as well as in freely assembled plug-type connectors by slight changes (for molding the particular catch elements on the contacts are not manufactured in the tool, see FIGS. 4, 5, 12, 15, 16 and 18). The direct molding of the contact shown in FIGS. 15 and 18 is significantly facilitated and even made possible in that the contact pin is elastically deformable and the female contact rigid. On the contact pin in FIG. 15 the front surface, located inside the pin and behind the spring arms, of the contact protector from FIG. 6, which is designed to be correspondingly long, serves as sealing surface in the molding tool. As a result of the possibility of directly molding such contacts, molded plugs as in FIG. 14 and sockets as in FIG. 17 can be partially or completely automatically manufactured in combination with a 2K spraying machine (2K signifies two components, i.e., two different plastics).

The plug and socket are locked in the assembled state in such a manner that a subsequent loosening is possible only with the aid of an appropriate tool. To this end the latch seats on the plugs (see FIGS. 2, 3 and 14) are designed to be so small that the stop barbs on the sockets (see FIGS. 10, 11 and 17) cannot be loosened by finger pressure. Furthermore, for this even the outer surfaces on the stop noses of these stop barbs must be held down in the locked state by an appropriate degree relative to the outer casing surface.

For compact construction the latch seats of the plugs (FIGS. 2, 3 and 14) are integrated into the wall of the actual plug space (in similar commercial solutions such openings are formed as flaps on the wall of the plug space).

1. A plug (1.1), preferably for use outside in solar-energy systems, which plug (1.1) comprises a contact carrier (1.1.1) in which a contact pin (1.1.2) is arranged and fastened and that carries on an end a cable sealing ring (1.1.3) with a strain-relief hook (1.1.4), which strain-relief hook (1.1.4) cooperates with a threaded compression sleeve (1.1.5) in order to decouple forces of traction and pressure that act on a cable (1.1.6) from the contact pin (1.1.2).

2. The plug (1.1) according to claim 1, characterized in that the contact carrier (1.1.1) is formed by a molded plastic and that the contact pin (1.1.2) is fixed by molding in the contact carrier (1.1.1).

3. The plug (1.1) according to claim 1, characterized in that the contact carrier (1.1.1) is formed by molded plastic and that the contact pin (1.1.2) is integrally fixed in the contact carrier (1.1.1).

4. A socket (1.2), preferably for use outside in solar-energy systems, which socket (1.2) comprises a contact carrier (1.2.1) in which a female contact (1.2.2) is arranged and fastened that carries on an end a cable sealing ring (1.1.3) with a strain-relief hook (1.1.4), which strain-relief hook (1.1.4) cooperates with a threaded compression sleeve (1.1.5) in order to decouple forces of traction and pressure that act on a cable (1.1.6) from the female contact (1.2.2).

5. The socket (1.2) according to claim 4, characterized in that the contact carrier (1.2.1) is formed by molded plastic and that the female contact (1.2.2) is fixed by the molding in the contact carrier (1.2.1).

6. The socket (1.2) according to claim 4, characterized in that the contact carrier (1.2.1) is formed by a molded plastic and that the female contact (1.2.2) is integrally fixed in the contact carrier (1.2.1).

7. The plug (1.1) or socket (1.2) according to one of the previous claims, characterized in that the contact pin (1.1.2) and/or the female contact (1.2.2) is designed as a stamped roll contact.

8. The plug (1.1) or socket (1.2) according to one of the previous claims, characterized in that the contact carrier (1.1.1) of the plug (1.1) comprises latch seats (1.1.7) and the contact carrier (1.2.1) of the socket comprises stop barbs (1.2.4) (or vice versa), which latch seats (1.1.7) on the plug (1.1) are designed to be so small that the stop barbs (1.2.4) on the socket (1.2) cannot be loosened by finger pressure.

9. The plug (1.1) or socket (1.2) according to claim 8, characterized in that the outer surfaces on the stop noses of the stop barbs (1.2.4) are held in the locked state depressed by a corresponding degree relative to the outer jacket surface of the contact carrier (1.1.1) of the plug (1.1).
